(19) United States
(12) Patent Application Publication
(10) Pub. No.: US 2004/0149029 A1
(43) Pub. Date: Aug. 5, 2004

(54) Reflective coating for a housing enclosure in a level measurement or time flight ranging system

(75) Inventor: Ian George Watson, Fraserville (CA)

Correspondence Address: MERCHANT & GOULD PC, P.O. BOX 2903, MINNEAPOLIS, MN, 55402-0903, US

(73) Assignee: Siemens Milltronics Process Instruments Inc., Peterborough (CA)

(21) Appl. No.: 10/663,595

(22) Filed: Sep. 16, 2003

(30) Foreign Application Priority Data
Jan. 31, 2003 (CA) 2,418,169

(51) Int. Cl. G01F 23/28

(52) U.S. Cl. 73/290 R; 73/431

(57) ABSTRACT

A housing or enclosure for time of flight ranging systems and/or level measurement devices. The housing comprises an upper lid section and a lower section which are coupled together to form an enclosure for holding a transducer module and electronic circuitry to provide the level measurement funtionality. The housing has an exterior surface which is covered in at least part with a reflective coating. The reflective coating reflects solar radiation and serves to reduce the solar gain and temperature rise variations inside and surrounding the housing. According to another aspect, the reflective coating may also be applied to all or parts of the interior surface.

### FIELD OF THE INVENTION

The present invention relates to level measurement and time of flight ranging systems, and more particularly to a housing or enclosure for a level measurement system or a time of flight ranging system and the housing having a reflective coating or surface for reflecting solar radiation.

### BACKGROUND OF THE INVENTION

Time of flight ranging systems are commonly used in level measurement applications, and referred to as level measurement systems. Level measurement systems determine the distance to a reflector (i.e. reflective surface) by measuring how long after transmission of a burst of energy pulses, an echo is received. Such systems typically utilize ultrasonic pulses, pulse radar signals, or microwave energy signals.

Time of flight and level measurement systems typically include a window in the housing to view a display/readout panel (e.g. LCD matrix) which is contained inside the housing. The display is contained in the housing for protection against the elements.

Such time of flight ranging and level measurement systems are often installed in harsh outdoor environments exposed to the elements. Exposure to sunlight results in solar gain through the window which can increase the temperature inside the housing and the electronic circuitry contained in the housing by as much as 30 degrees Centrigrade.

It is undesirable to subject level measurement and time of flight systems incorporating precision electronic circuitry to such high temperatures and ranges of temperature change.

### BRIEF SUMMARY OF THE INVENTION

The present invention provides a housing for a level measurement system or time of flight ranging system with the housing having a reflective surface for reducing solar gain.

In one aspect, a reflective coating is applied to the surface of a lid for a time of flight ranging system or level measurement system.

In another aspect, the time of flight ranging system or level measurement system comprises a housing having a window. The window is partially covered with a reflective coating.

In a first aspect, the present invention provides housing for a level measurement system, the housing comprises: (a) an upper section; (b) a lower section; (c) the upper and the lower sections are coupled together to define an enclosure for housing electronic circuitry associated with the level measurement system; (d) a reflective coating applied to a least a portion of the upper section, wherein the reflective coating is effective to reflect solar radiation.

In a further aspect, the present invention comprises a level measurement system having (a) a transducer for emitting energy pulses and detecting reflected energy pulses; (b) a controller having a component for controlling the transducer and a component for determining a level measurement based on the time of flight of the reflected energy pulse; (c) a power supply input port for receiving power to operate the level measurement device; (d) an enclosure for containing the transducer, the controller and the transmitter and the receiver components, and having a window for the liquid crystal display module; (e) the enclosure having an exterior surface and a reflective coating being applied to at least a portion of the exterior surface, and wherein the reflective coating is adapted to reflect solar radiation

Other aspects and features of the present invention will become apparent to those ordinarily skilled in the art upon review of the following description of specific embodiments of the invention in conjunction with the accompanying drawings.

### BRIEF DESCRIPTION OF THE DRAWINGS

Reference is next made to the accompanying drawings which show, by way of example, embodiments of the present invention and in which:

FIG. 1 shows a time of flight ranging system or level measurement system having a housing according to one embodiment of the invention;

FIG. 2 shows a housing for a time of flight ranging system having a window with a reflective coating according to another embodiment of the present invention;

FIG. 3 shows a level measurement system incorporating a housing according to the present invention.

### DETAILED DESCRIPTION OF EMBODIMENTS OF THE INVENTION

Reference is first made to FIG. 1 which shows a time of flight ranging system, such as a level measurement system, and is indicated generally by reference 10. The level measurement system 10 comprises a housing or enclosure 12 and electronic circuitry (as shown below) which is contained inside the housing 12.

The housing 12 comprises a lid or upper portion 14 and a body or lower portion 16. The lid 14 is either hinged, snap connected or otherwise detachably coupled to the body 16 to allow access to the electronic circuitry for assembly and/or maintenance.

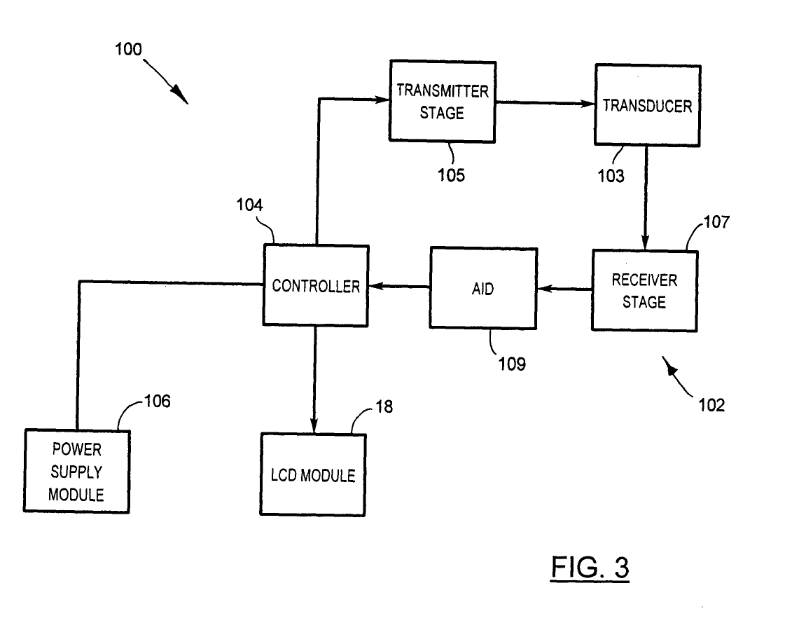

The electronic circuitry is contained inside the housing 12 and for the level measurement system 10 comprises a transducer, a transmit module, a receiver module, a controller and a power supply module (as described below with reference to FIG. 3). The level measurement system 10 may also include a display, e.g. a liquid crystal display (LCD) module 18 which is mounted adjacent a window 20. The LCD module 18 is coupled to the controller (FIG. 3) and displays various operating and status parameters for the level measurement system 10.

According to this aspect of the invention, the lid 14 of the housing 12 is coated with a reflective material depicted by cross-hatching indicated generally by reference 22 in FIG. 1. The reflective material 22 comprises a material having properties for reflecting solar radiation. Suitable materials for the reflective material 22 include thin metallic foils, for example, gold, silver or aluminum, or a mirrored finish which is applied to the surface of the lid 14.

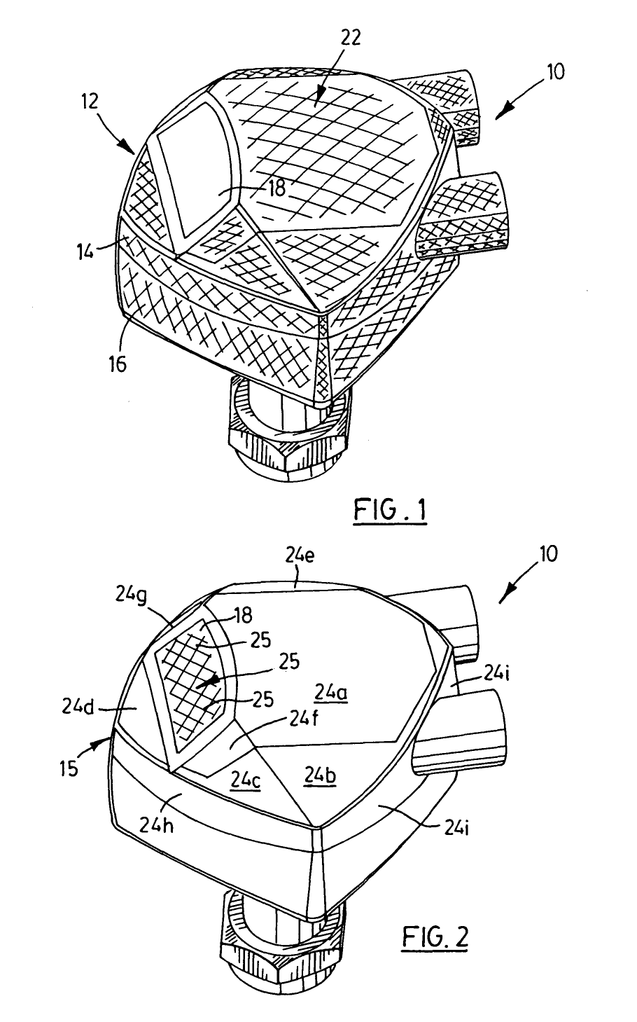

The reflective material 22 may be applied to the entire surface or exterior of the lid 14 as depicted in FIG. 1. According to another aspect, the reflective material may be applied to a selected portion or portions of the lid 14. For example, the reflective material is applied to panels 24, indicated individually by references 24a, 24b, 24c, 24d, 24e, 24d, 24g, 24h, . . . in FIG. 2 on a lid indicated by reference 15. The reflective material 22 may also be applied to portions or all of the interior surface of the lid 14. For example, reflective material indicated by reference 25 in FIG. 2 is applied to the interior surface of the lid 14 adjacent the window 18. The reflective material 25 serves to reflect solar radiation which is transmitted by the window 18.

Reference is next made to FIG. 3, which shows a level measurement system or time of flight ranging system 100 with a housing according to the present invention. The level measurement system 100 comprises a transducer module 102, a controller 104 and a power supply module 106. The level measurement system 100 includes the LCD module 18.

As shown in FIG. 3, the transducer module 102 is coupled to a control port and input/output port on the controller 104. The transducer module 102 includes a transducer 103, a transmitter stage 105 and a receiver stage 107. The transducer 103 may comprise radar-based technology, ultrasonic based technology, TDR-based technology (Time Domain Reflective), or other distance ranging technology. Under the control of a program stored in memory (i.e. firmware), the controller 104 generates a transmit pulse control signal for the transmit stage 105 in the transducer module 102, and the transducer 103 emits a transmit burst of energy, for example, radar pulse(s) directed at the surface of a material contained in a storage vessel (not shown). The reflected or echo pulses, i.e. the propagated transmit pulses reflected by the surface of the material, are coupled by the transducer 103, for example, a radar antenna or other distance ranging technology (not shown), in the transducer module 102 and converted into electrical signals by the receiver stage 107. The electrical signals are inputted by the controller 102 and sampled and digitized by an analog-to-digital (A/D) converter 109 and a receive echo waveform or profile is generated. The controller 104 executes an algorithm which identifies and verifies the echo pulse and calculates the range, i.e. the distance to the reflective surface, from the time it takes for the reflected energy pulse to travel from the reflective surface to the transducer in the transducer module 102. From this calculation, the distance to the surface of the material and thereby the level of the material in the vessel is determined. The controller 104 may comprise a microprocessor or a microcontroller, with on-chip resources, such as the A/D converter, ROM (EPROM), RAM. The microprocessor or microcontroller is suitably programmed to perform these operations as will be within the understanding of those skilled in the art.

The present invention may be embodied in other specific forms without departing from the spirit or essential characteristics thereof. Certain adaptations and modifications of the invention will be obvious to those skilled in the art. Therefore, the above discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A housing for a level measurement system, said housing comprising:
(a) an upper section;
(b) a lower section;
(c) said upper and said lower sections being coupled together to define an enclosure for housing electronic circuitry associated with the level measurement system;
(d) a reflective coating applied to a least a portion of said upper section, wherein said reflective coating is effective to reflect solar radiation.

2. The housing as claimed in claim 1, wherein said reflective coating is applied to the entire surface of said upper section.

3. The housing as claimed in claim 2 or 3, wherein said reflective coating is applied to at least a portion of the interior surface of the housing.

4. The housing as claimed in claim 2 or 3, wherein said reflective coating comprises a metallic film.

5. The housing as claimed in claim 2 or 3, wherein said reflective coating comprises a mirrored finish.

6. A level measurement system comprising:
(a) a transducer for emitting energy pulses and detecting reflected energy pulses;
(b) a controller for controlling said transducer, said controller being coupled to a transmitter component and said transmitter component being responsive to said controller for generating transmit control signals for said transducer, said controller being coupled to a receiver component and said receiver component generating receive signals for said controller in response to detecting reflected energy pulses by said transducer, and said controller including a component for determining a level measurement reading based on said receiver signals;
(c) a liquid crystal display module for displaying said level measurement reading and one or more operating parameters;
(d) an enclosure for containing said transducer, said controller and said transmitter and said receiver components, and having a window for said liquid crystal display module;
(e) said enclosure having an exterior surface and a reflective coating being applied to at least a portion of said exterior surface, and wherein said reflective coating is adapted to reflect solar radiation.

7. The level measurement system as claimed in claim 6, wherein said reflective coating is applied to the entire surface of said housing.

8. The level measurement system as claimed in claim 6 or 7, wherein said reflective coating comprises a metallic film.

9. The level measurement system as claimed in claim 6 or 7, wherein said reflective coating comprises a mirrored finish.

10. The level measurement system as claimed in claim 6, wherein said enclosure has an interior surface, and a reflective coating is applied to at least a portion of said interior surface, and wherein said reflective coating is suitable to reflect solar radiation.

11. The level measurement system as claimed in claim 10, wherein said reflective coating comprises a metallic form.

12. The level measurement system as claimed in claim 10, wherein said reflective coating comprises a mirrored finish.
